(19) United States
(12) Patent Application Publication
(10) Pub. No.: US 2005/0196328 A1
(43) Pub. Date: Sep. 8, 2005

(54) Hydraulic device for the thermo-pneumatic isolation and optional agitation of the contents of an operative cavity

(75) Inventors: Yves Fouillet, Voreppe (FR); Patrick Pouteau, Mevlan (FR); Nicolas Sarrut, Seyssinet-Pariset (FR); Frederic Ginot, Saint Egreve (FR); Dominique Masse, Coublevie (FR)

Correspondence Address: OLIFF & BERRIDGE, PLC, P.O. BOX 19928, ALEXANDRIA, VA, 22320, US

(73) Assignees: Bio Merieux, Marcy-L'Etoile (FR); Commissariat A L'Energie Atomique, Paris (FR)

(21) Appl. No.: 10/518,343

(22) PCT Filed: Jun. 24, 2003
(86) PCT No.: PCT/FR03/01946

§ 371 Date: Jan. 5, 2005

(30) Foreign Application Priority Data
Jun. 24, 2002 (FR) 02/08038

(51) Int. Cl. B01L 3/02

(52) U.S. Cl. 422/100

(57) ABSTRACT

The invention relates to hydraulic device produced from one or several components, for example from a support comprising: an operative cavity, at least two ducts, for example an inlet and outlet for a liquid of interest which communicate with said operative cavity, at least two valve bodies with no moving pieces for control of said cavity. The above is characterised in that said device further comprises two trapping chambers for a gas, for example, air, in communication only and respectively with two ducts, by means of two connecting channels respectively, both pertaining to thermal exchange with a heat source.

The present invention relates to a fluidic device comprising or associated with an operative cavity of the reactor type, allowing, without any mechanical or moving parts, firstly, the isolation of the content of said cavity and, secondly, the isolation with agitation of the content of this cavity.

More particularly, the invention relates to a fluidic device of the microfluidic type, which can be used, by way of example, in systems or devices of the “lab-on-a-chip” type. Today, microfluidics is a technical field that is undergoing development for the purposes of various medical, pharmaceutical, biological and chemical applications. In simple terms, it involves treating liquids, gases and solids, where appropriate, in devices or structures for which the unit volume is between 1 nanoliter and 1 microliter. On this scale, it is consequently necessary or preferred to exclude all mechanical pieces, in particular with a moving part, and, by way of example, thermopneumatics is selected as actuating or motor principle, in particular for the circulation of liquid in such systems.

The main functions required on a much larger scale for treating liquids and gases have been designed and developed so as to be suitable on a microfluidic scale.

As regards, first of all, valves or gates, or more generally means allowing any control of the flow rate of a liquid, various solutions using microbubbles of gas or vapor have been proposed. By way of example, reference will be made to the following publications:
A) Y.S-Leung Ki, M. Kharouf, HTG Van Lintel, M. Haller, Ph. Renaud, Bubble Engineering Valving applications, IEEE-EMBS, 200, 390-393.
B) Alexandros P. Papavasilliou, Doran Liepmann, Albert P. Pisano, Electrolysis-Bubble Actuated Gate Valve, Solid-State Sensor and Actuator Workshop, 2000, 48-51.

As regards the pumping function of a liquid, and more generally the increase in pressure of a said liquid, mention will be made, by way of example, of the following publications:
C) Jr-Hing Tsai and Liwei Lin, A thermal bubble actuated micro nozzle-diffuser pump, 14th IEEE Inter. Conf. On MEMS 2001, 409-412;
D) K. Handique, D. T. Burke, C. H. Mastrangelo, and M. A. Burns, On-Chip thermopneumatic pressure for discrete drop pumping, Analytical chemistry, Vol. 73, No. 8, 2001, 1831-1838; cf. U.S. Pat. No. 6,130,098 and U.S.-A-2002/01 0492.

As regards also the mixture of two components and, for example, of two liquids, reference will be made to the following work:
E) Wolfgang Ehrfeld, Wolker Hessel, Holger Lowe, Microreactors, New Technology for Modern Chemistry, Wiley-VCH, 2000, 41-83.

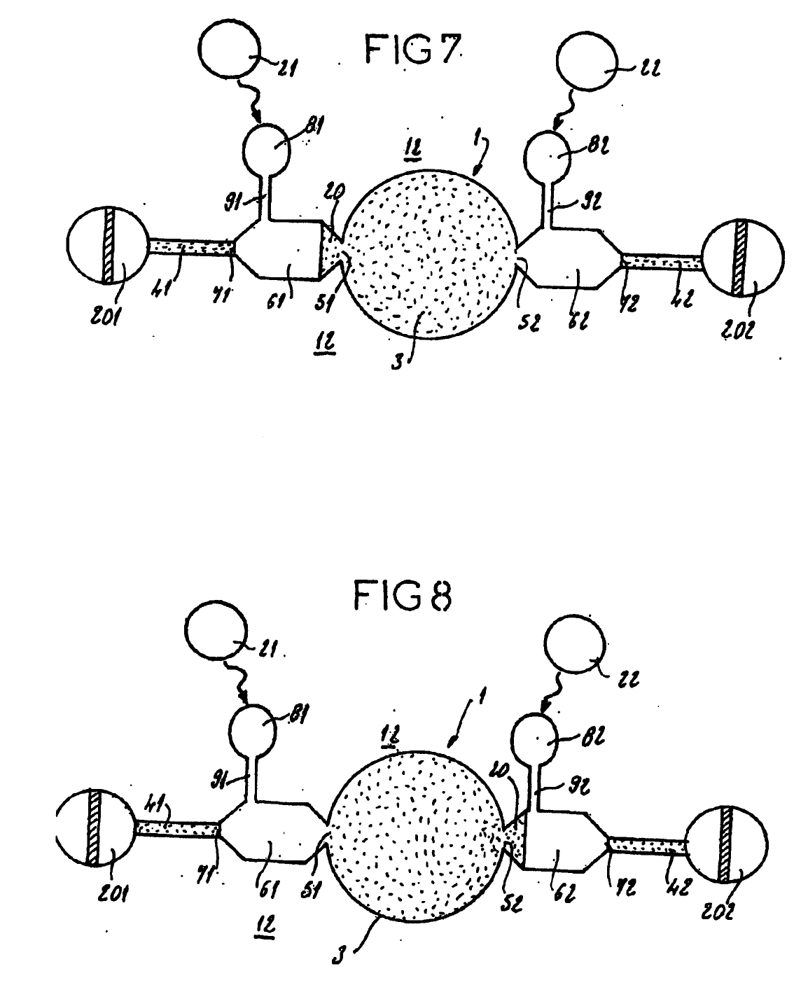

In accordance with U.S. Pat. No. 6,193,471, a fluidic device has been described for forming and transporting predetermined volumes of a liquid. For this purpose, according to an embodiment described with reference to FIG. 7, a fluidic section is provided, comprising, in series, a reserve chamber, a first storage cavity, a portion of capillary duct, and a second storage cavity. The reserve chamber and the two storage cavities are in communication with an outside pressure source. In order to form and transport a predetermined volume of liquid:
from the reserve chamber, the portion of capillary duct is filled with liquid, through the first storage cavity, and stopping at the second storage cavity; the portion of capillary duct between the two storage cavities defines the predetermined volume of liquid,
by increasing the pressure in the first storage cavity, the liquid is returned to the reserve chamber, isolating the predetermined volume of liquid between two menisci located, respectively, at the two storage cavities,
by increasing the pressure in the first storage cavity, the predetermined and isolated volume of liquid is transferred beyond and through the second storage cavity.

In accordance with U.S. Pat. No. 6,193,471, the formation and the transport of an isolated volume of liquid are obtained by means of the differentiated control, from the outside, of a pressure, respectively in the reserve chamber and in the storage cavities, these control means, which are particularly complex, being represented, for example, with reference to FIGS. 13 and 14.

In accordance with U.S. Pat. No. 4,676,274, a microfluidic device is described, consisting of an arrangement of capillary ducts comprising various capillary valves, with no moving parts, each constructed so as to generate an overpressure at the interface between a control gas and a liquid of interest, or meniscus. Through the outside control of the control gas, into or out of the fluidic device, at the various capillary valves, the liquid of interest can be circulated or “pumped” according to any pre-established process.

In accordance with U.S. Pat. No. 6,117,396, a microfluidic device has been described, for distributing predetermined volumes of a liquid of interest, from one and the same inlet duct, by means of an external source of gas injected into said device so as to displace said predetermined volumes.

In a microfluidic device of the type such as those defined or described above, the present invention relates specifically to the following function, namely the isolation in an operative cavity of a volume of liquid that fills said cavity, optionally with stirring of said volume in said cavity.

The object of the present invention is to effect this function with particularly simple fluidic means.

To this end, a fluidic device according to the present invention, produced from one or more components, for example from a support, comprises:
an operative cavity,
at least two ducts, for example an inlet and an outlet duct for a liquid of interest, which communicate with the operative cavity, respectively by means of two valve bodies with no moving parts, of the gate type, making it possible to control the operative cavity,
two trapping chambers for a gas, for example air, which communicate only and respectively with the two ducts, by means of two distinct channels for connecting, respectively, said two ducts,
means for heat exchange with one and/or the other trapping chamber, in order to control the pressure of the gas in one and/or the other said trapping chamber.

Consequently, according to the present invention, on either side of the operative cavity, an inlet or outlet duct and a channel for connection with a trapping chamber communicate, directly or indirectly, with the same valve body with no moving parts, of the gate type, placed on the operative cavity. In other words, a said connecting channel is connected up to an inlet or outlet duct, for example by means of an expansion chamber, as described or defined hereinafter.

By way of example, the ducts under consideration in the present invention are capillary ducts, in the sense that, with respect to a predetermined liquid, they are capable of containing the latter at a certain height against gravity. By way of illustration, such ducts have a cross section whose transverse dimension (or diameter) does not exceed 1.5 mm, for example of the order of 500 μm.

When, according to the present invention, a “cavity” or “chamber” is envisioned, the shape and/or the dimensions thereof differentiate it from a duct in the sense that, following one dimension, for example in the direction of circulation of the liquid, the other dimension(s) of the cavity or chamber are greater than that, for example transverse, of a duct.

A device according to the present invention constitutes, by means of the trapping chambers, a thermopneumatic system in the sense that only thermal actuation makes it possible to control the pressure and/or the volume of the gas in the trapping chambers.

Preferably, the device comprises, on either side of the operative cavity, two isolating means placed, respectively, on the two ducts, for example inlet and outlet ducts, each constructed to take up two positions, namely a position which establishes communication of one said duct with the outside, and another position which isolates said duct from the outside. By isolating the device with respect to the outside, by means of the two isolating means in the closed position, said device becomes a closed thermodynamic system, in particular with respect to the gas which it contains, trapped in the trapping chambers.

Preferably, a device according to the present invention comprises two expansion chambers, each one placed between said operative cavity and each duct, each chamber communicating on one side with said duct by means of a first capillary valve with no moving parts, that opposes any capillary liquid passage, that opposes any flow of liquid to said chamber and, on the other side, with said cavity by means of a second capillary valve, that opposes any flow of liquid to said chamber.

By way of example, the two connecting channels each connect a trapping chamber with an expansion chamber. In addition, each expansion chamber constitutes the junction between an inlet or outlet duct and a channel for connection with a trapping chamber, on each side of the operative cavity.

The means for controlling the pressure and/or the volume of the gas in one and/or the other trapping chamber are:
two hot sources pertaining to heat exchange with, respectively, the two trapping chambers,
or a single hot source pertaining to heat exchange with the two trapping chambers.

The term “hot source” is intended to mean any source capable of providing and/or receiving heat.

Each of these hot sources may be an integrated resistor on the valve of the fluidic device, for example a platinum resistor produced by photolithography, on a valve made of glass, aligned facing one or other trapping chamber during the assembly of the valve with the support. This resistor may have a resistance of around 25 to 50 ohms.

Each of these hot sources may be an emitter of radiation, for example infrared radiation, capable of being absorbed by the gas present in the trapping chambers.

According to another embodiment, it may be advantageous to have only one hot source, alternatively placed facing one and then the other trapping chamber.

The present invention is now described with reference to the attached drawing, in which:

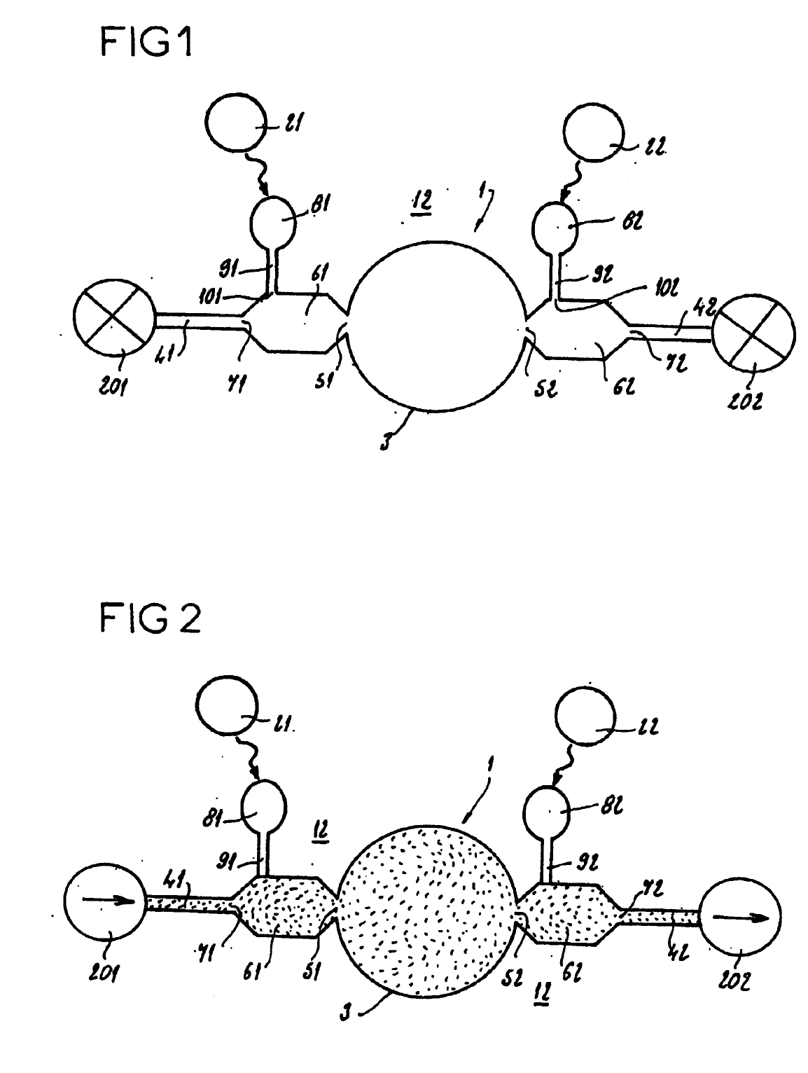

FIG. 1 represents, diagrammatically, a fluidic device in accordance with the present invention;

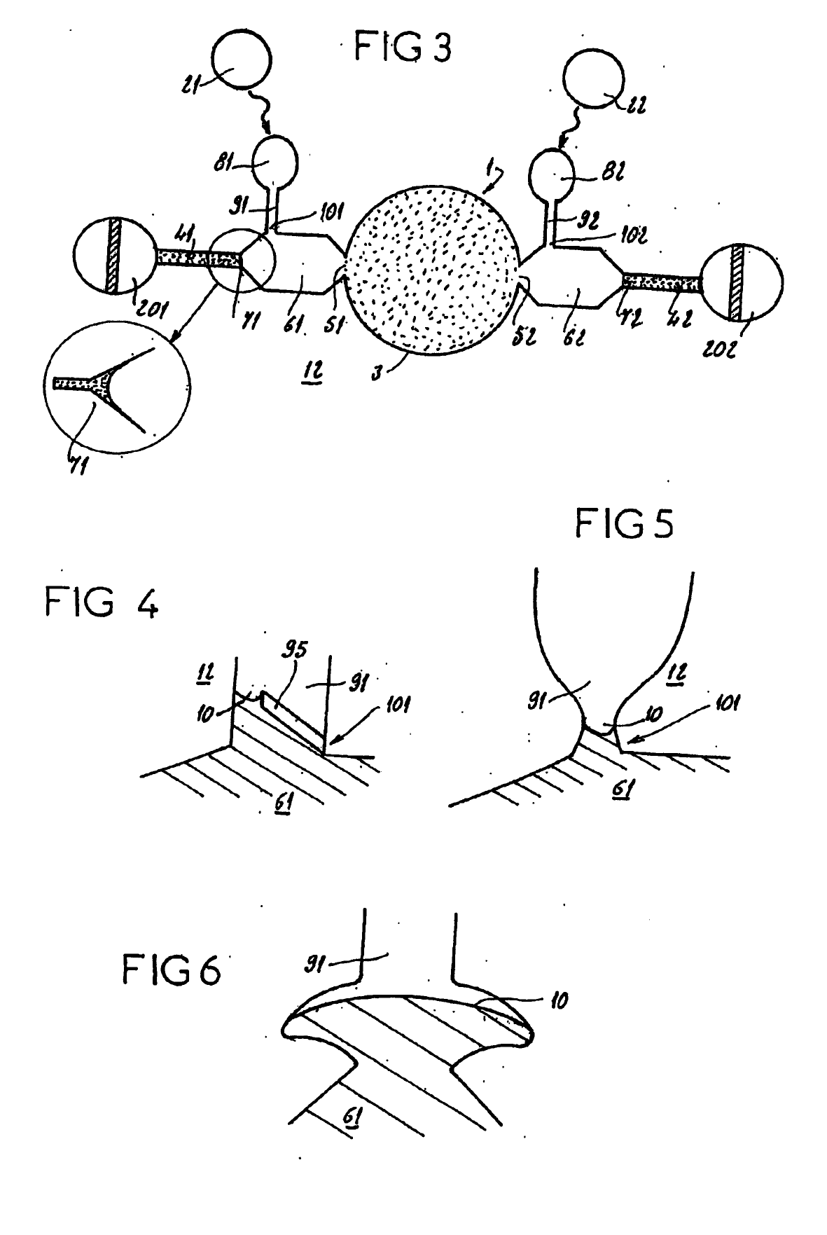

FIGS. 2 and 3 represent, still diagrammatically, two phases of use of the device according to FIG. 1, for isolating or confining a volume of a liquid of interest in the operative cavity, belonging to said device;

FIGS. 4 to 6 represent, diagrammatically, respectively three embodiments of any capillary valve belonging to a device according to the invention and, by way of example, placed at the junction between a connecting channel and an expansion chamber belonging to the device according to FIG. 1;

FIGS. 7 and 8 represent, respectively, two phases of use of the device represented in FIG. 1, for agitating the content of the operative cavity belonging to said device;

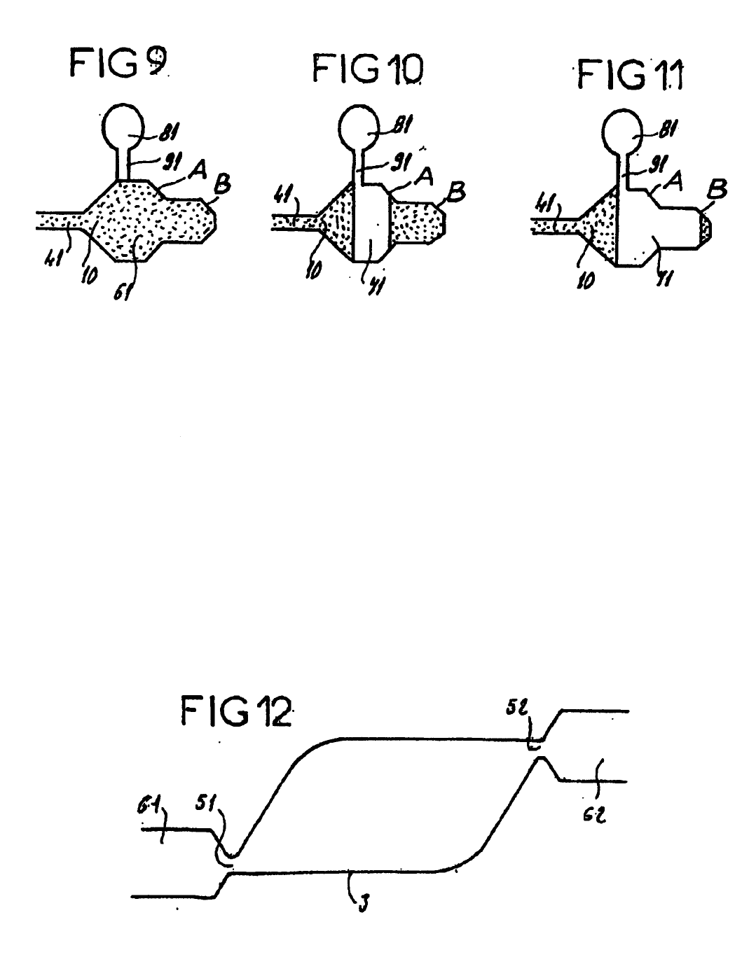

FIGS. 9 to 11 represent another “threshold” embodiment of an expansion chamber belonging to a device according to FIG. 1, FIGS. 9 to 11 representing diagrammatically and respectively three phases of the thermal control of such an expansion chamber;

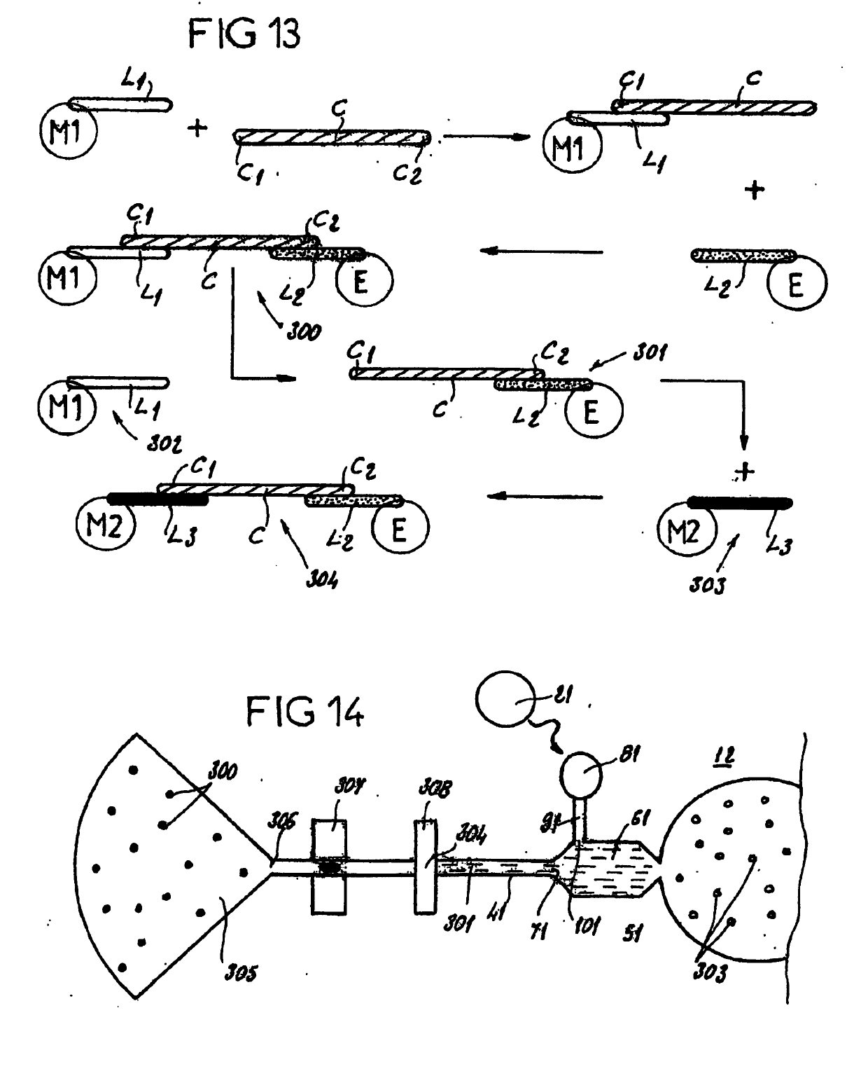

FIG. 12 represents an embodiment of the operative cavity of a fluidic device in accordance with the present invention;

FIG. 14 represents a device according to the present invention, modified so as to implement the immunoassay format represented diagrammatically in FIG. 13.

In accordance with FIG. 1, a device according to the invention is produced by means of microtechnology, making it possible to obtain, in any flat support, for example a hollow structure represented diagrammatically on a large scale in FIG. 1. Ranking among this microtechnology, mention may be made of chemical or plasma etching of a silicon or glass support, machining, hot-embossing, and injection molding or laser beam ablation of a flat support, for example made of plastic, such as a polycarbonate. In practice, the starting point is a flat support; the hollow structure represented diagrammatically in FIG. 1 is obtained using one of the faces of the support and this hollow structure is sealed, in a leaktight manner, by means of at least one closure plate or film placed opposite the face of the support in which the hollow structure has been made, and sealed or bonded against said support, a suitable cover covering the entire assembly if necessary.

In general, with reference to FIG. 1, the hollow structure defines, in the support (12), a fluidic device (1) comprising:
an operative cavity (3) or microreactor,
at least two ducts (41, 42), for example inlet (41) and outlet (42) ducts, for a liquid of interest (not represented in this figure), which communicate indirectly with the operative cavity (3),
two trapping chambers (81) and (82) for a gas, for example air, which communicate, respectively, only and indirectly with the two ducts (41, 42), by means of the two expansion chambers (61) and (62) defined hereinafter and two connecting channels (91, 92), respectively, the two chambers (81 and 82) each pertaining to heat exchange with a hot source (21, 22),
two expansion chambers (61) and (62), each one placed between said operative cavity (3) and each duct (41) or (42), each chamber communicating, on one side, with one said duct (41) or (42) by means of a first capillary valve (71) or (72), i.e. a valve with no moving parts, of the capillary restriction type, that opposes any flow of liquid to said expansion chamber and, on the other side, with the operative cavity (3) by means of a second capillary valve (51) or (52), as defined above, that opposes any flow of liquid to the expansion chamber,
the two connecting channels (91, 92) each connecting a trapping chamber (81) or (82) with an expansion chamber (61) or (62),
two capillary valves (101) and (102) as defined above, by means of which the connecting channels (91, 92) communicate, respectively, with the corresponding expansion chambers (61) and (62), these two capillary valves opposing any flow of liquid to the trapping chambers (81) and (82), respectively,
two isolating means (201 and 202), placed respectively on the two ducts (41 and 42), on either side of the operative cavity (3), each constructed so as to take up two positions, namely an open position which establishes communication of one said duct with the outside, and a closed position which isolates said duct from the outside.

The term “capillary valve”, and with reference by way of example to the valve represented as an enlargement under reference (71) in FIG. 3, is intended to mean a valve with no moving parts, consisting of a capillary-type restriction, that opposes any flow of liquid in a given direction, for example to the expansion chamber (61) relating to the valve (71), in FIG. 3. In practice, such a capillary valve is constructed so as to generate an interface between a gas, for example residual air, and a liquid, for example the liquid of interest which interface is in practice referred to as a meniscus, the latter generating an overpressure that opposes, in general, any flow of liquid beyond the valve, of course below a given pressure, or threshold pressure.

In practice, the formation and the reproducibility of such a meniscus depend on many factors, among which mention may be made of:
the geometry of the edges or walls at which the meniscus is obtained,
the wettability of the liquid and/or its surface tension with respect to the material constituting said edges or walls, any appropriate treatment of the latter, for example of hydrophobic or hydrophilic type, being in particular able to modify the abovementioned properties with respect to the liquid.

As shown by way of example in FIG. 1, but also in the enlargement of FIG. 3, it is the relative geometry of the edges or walls that is selected in order to generate any capillary valve as defined above functionally.

In practice, given the microtechnology used, the operative cavity (3) constitutes, for example, a microreactor having a volume of around 0.1 μl, the expansion chambers (61) and (62) having a volume of around 0.03 μl, and also the trapping chambers (81) and (82) having a volume of around 0.03 μl to 0.15 μl.

In practice, a fluidic device 1 as described above is, moreover, suitable (but in a manner not represented) for working in a technical environment that provides it with:
heat and/or cold, in order to heat and/or cool, firstly, the entire device 1 and, optionally separately, the trapping chambers (81) and (82), by means of sources of heat and/or of cold (21) and (22) pertaining to heat exchange only and respectively with said chambers (81) and (82);
a pressure or load, at the outlet of the device, for example in the outlet duct (42);
a source of pressure or load, at the inlet of the device, for example in the duct (41), in general greater than the outlet pressure, for example in the duct (42), by any appropriate means, such as a height of liquid greater than the height of liquid at the outlet of said device, for example in the case of filling under pressure, or by means of a syringe, itself mounted on a syringe pump.

During the active operating phase of a device according to the invention, i.e. the isolation of the operative cavity filled with the liquid of interest, with or without agitation, said device is isolated from the outside by the means 201 and 202, in the closed position, and constitutes a closed system of heat exchange with the sources 21 and/or 22.

By construction, according to the support (12), the geometry and the size of the fluidic device (1), those skilled in the art will adopt and adjust many parameters, so as to obtain stable and reproducible operation of said device. Among these parameters, mention may be made of:
the wettability of the liquid(s) used, relative to the internal surface of the device, taken into consideration in particular with respect to its geometry and its surface characteristics,
the outside pressures upstream and downstream of the device, i.e. at the level of the inlet (41) and outlet (42) ducts, respectively,
the temperatures and the heat exchanges, and also the control thereof, between the various parts of the device.

The form of the operative cavity (3) can be optimized according to the application envisioned. The capillary form, shown in FIG. 12, may be advantageous for certain chemical reactions; this form appears to be suitable for correct agitation of the liquid of interest, so as to obtain a more homogeneous or more complete reaction.

The device described above is now used for isolating or confining the content of an operative cavity (3), according to the operations, defined hereinafter.

At the start, the device (1) is empty, and the isolating means (201 and 202) are in the open position, as shown in FIG. 2. It is therefore, for example, filled naturally with ambient air, under atmospheric pressure, or under a higher pressure, according to the inlet and outlet pressures of the device, as indicated above.

Preferably, the operative cavity (3) and the expansion chambers (61) and (62) are filled by forced circulation, for example by means of an external pump, of the liquid of interest, from the inlet duct (41) to the other, outlet duct (42), retaining a residual gas and therefore ambient air in the two trapping chambers (81) and (82). The ambient air is therefore trapped in the chambers (81) and (82) at a “filling” temperature, which may be identical to or different from ambient temperature, and at a pressure that is substantially equal to the outlet pressure, i.e. that available in the duct (42).

Given the capillary valves (101) and (102) described above, resulting from the construction of the device according to FIG. 1, the liquid present in the expansion chambers (61) and (62) is prevented from penetrating into the connecting channel (91) or (92) to the trapping chambers (81) and (82), respectively.

FIGS. 4 to 6 describe various possible forms of capillary valve.

FIGS. 4 and 5 illustrate a narrowing of the cross section of the capillary in the case of a wetting liquid. Conversely, in the case of a nonwetting liquid, the cross section of the capillary widens and it is this which allows blocking of the meniscus at the valve (cf. FIG. 6).

The overpressure thus obtained at a capillary valve as described above means that the requirement as to the pressure to be applied to the residual gas is not as great.

The capillary valve (101) or (102) can be produced according to one of the embodiments represented diagrammatically in FIGS. 4 and 5, respectively. According to FIG. 4, a baffle (95) is placed at an angle to the base of the connecting channel (91) and (92), directed toward the corresponding trapping chamber (81) or (82). According to FIG. 5, a restriction is introduced at the base of the connecting channel (91) or (92).

After circulation of the liquid of interest, the state of the device represented in FIG. 2, in which the ducts (41) and (42), the expansion chambers (61, 62) and the operative cavity (3) are filled, is therefore obtained.

The device is then isolated by placing the isolating means (201 and 202) in the closed position, as represented in FIG. 3.

Next, the residual gas is brought into the two trapping chambers (81) and (82) at an “isolating” temperature, that is greater than the temperature previously referred to as filling temperature, so as to bring the pressure in the trapping chambers (81) and (82) to a value that is sufficient to evacuate all the liquid of interest from the two expansion chambers (61) and (62), by means of the two ducts (41) and (42), respectively. As a result, the expansion chambers (61) and (62) are filled with two bubbles of residual gas, isolating the operative cavity (3) with respect to any leakage of the liquid of interest and/or to any diffusion of the particles contained in said liquid of interest, to the ducts (41) and (42), or from said ducts (41) and (42) to said cavity (3).

Throughout the description, the term “particle” is intended to mean any discrete element, for example an element carrying biological information, such as an electrically charged, magnetic or nonmagnetic particle carrying a biological molecule.

The state of the device represented in FIG. 3 is thus achieved, in which the operative cavity (3) and the ducts (41) and (42) are filled. In this state, the liquid is prevented from penetrating from the ducts (41) and (42) by virtue of the capillary valves (71) and (72) described above, which exist naturally through the construction of the device, or which are specifically produced for this purpose. Similarly, the liquid is prevented from penetrating from the operative cavity (3) into the expansion chambers (61) and (62), respectively by virtue of the capillary valves (51) and (52).

This isolating step can be carried out according to different modes:
either the entire device is heated to the “isolating” temperature and, in such a case, the two bubbles of the residual gas form simultaneously in the chambers (61) and (62),
or the trapping chambers (81) and (82) are heated one after the other respectively with the hot sources (21) and (22), and the two bubbles of the residual gas are obtained one after the other, in the expansion chambers (61) and (62),
or the entire device is heated, in particular for carrying out a chemical reaction within a reaction mixture in the operative cavity (3), and the trapping chambers (81) and (82) are heated, in addition, one after the other.

As regards the trapping chambers (81) and (82), they are of a size such that they initially contain a volume of the residual gas which, when heated to the “isolating” temperature, completely or partially occupies the expansion chambers (61) and (62) respectively. Moreover, these same chambers (81) and (82) have a compensating role, when liquid naturally returns toward them at the time the device is cooled to a temperature that is optionally lower than the filling temperature. As soon as the temperature increases again, the liquid returns, without being captured in the chambers (81) and (82), to the expansion chambers (61) and (62) respectively.

It is clearly understood that the use of the fluidic device (1), for the purposes of isolating or confining an operative cavity (3) described above, can be carried out without the expansion chambers (61) and (62).

According to the description above, it is therefore possible to isolate a reaction mixture against the diffusion to the outside of any particles or species that it contains, in a particularly simple manner, and in particular by means of a purely thermopneumatic, in particular thermodynamic, actuation of the device. By virtue of this confinement, the concentration of the reaction mixture is not modified, which may be essential for the yield and for the integrity of the reaction carried out.

The use of the same fluidic device (1) for agitating the content of the operative cavity (3) will now be described. For such a use:
the two expansion chambers (61) and (62) are substantially identical, in particular in volume,
the two trapping chambers (81) and (82) are substantially identical, in particular in volume,
and the two trapping chambers (81) and (82) are heated in a localized and independent manner by means of the hot sources (21, 22) respectively.

As already described with reference to FIG. 2, beforehand, the operative cavity (3) and the two expansion chambers (61) and (62) are filled by circulating the liquid of interest from the inlet duct (41) to the other, outlet duct (42), retaining the residual gas in the two trapping chambers (81) and (82), at a predetermined temperature, previously referred to as filling temperature. The device is therefore in the state represented diagrammatically in FIG. 2.

The device (1) is isolated with the means (201 and 202) in the closed position.

The temperature of the residual gas in both the trapping chambers (81) and (82) is increased from the filling temperature to a reference temperature; this increase in the temperature in the chambers (81) and (82) is preferably simultaneous. However, the reference temperature in the trapping chamber (82) has a high value that is greater than the “low” value in the other trapping chamber (81). Because of this difference in reference temperatures, respectively in the chambers (81) and (82), the expansion chamber (62) is completely filled with a bubble of the residual gas, while the expansion chamber (61) is partially filled with the same residual gas. Consequently, firstly, a discrete quota (20) of the liquid of interest remains in the expansion chamber (61) and, secondly, the residual gas is compressed on the side of the expansion (61) and trapping (81) chambers. The state of the device represented in FIG. 7 is thus achieved.

Between the states of the device (1) represented, respectively, in FIGS. 2 and 7, the volume of the liquid of interest displaced has flowed toward the inlet (41) and/or outlet (42) ducts. If necessary, it is possible to heat the residual gas present in the trapping chamber (81) and then the residual gas present in the trapping chamber (82), which facilitates the evacuation of the liquid toward the outlet duct (42).

Next, the temperature of the residual gas in the other trapping chamber (81) is increased, by an increment Δt, from the reference temperature previously attained, while the reference temperature in the trapping chamber (82) is not modified. It is of course possible to simply reverse the heat exchanges of the heat sources (21, 22) in order to achieve the same result. Consequently, firstly, the quota (20) of the liquid of interest is displaced from the operative cavity (3) to the expansion chamber (62) associated with the trapping chamber (81), and is thus evacuated from the expansion chamber (61) and, secondly, the residual gas is compressed in the expansion chamber (62).

The state of the device represented in FIG. 8 is thus achieved.

This cooling may be advantageously obtained naturally, by simple convection and dissipation of the heat, since the fluidic device according to the invention has very small dimensions.

The temperature of the residual gas in the other (81) of the trapping chambers is then returned to the “reference” temperature, at its low value, in return for which the same quota (20) is displaced to the expansion chamber (61) associated with said trapping chamber (81), so as to again achieve the state represented diagrammatically in FIG. 7.

The operations described above can be brought about a whole number of times, so as to generate oscillations in the discrete quota (20) on either side of the operative cavity (3). These oscillations may be obtained at frequencies of 0.5 Hz to 25 Hz. They may be brought about over a period of the order of one hour, corresponding to the duration of the chemical (or other) reaction in the operative cavity (3).

Consequently, the fluidic device (1) according to FIG. 1 can be used, in order to isolate or confine and agitate all or some of a liquid of interest in the operative cavity (3), according to the following operative steps:
a) the operative cavity (3) and the expansion chambers (61, 62) are filled, beforehand, by circulating the liquid of interest from an inlet duct (41) to the other, outlet duct (42), retaining a residual gas in the two trapping chambers (81, 82),
b) after circulation of the liquid of interest, the residual gas in the two trapping chambers is brought to an “isolating” temperature, so as to bring the pressure in said trapping chambers to an “equilibrium pressure” value that is sufficient to evacuate all or part of the liquid of interest from the two expansion chambers (61, 62) by means of at least one of the two ducts (41, 42), and to fill all or part of said chambers with two bubbles of the residual gas, isolating the operative cavity with respect to any leakage of the liquid of interest and/or to any diffusion of the particles contained in said liquid of interest to said ducts (41, 42),
c) the temperature of the residual gas present in at least one of the trapping chambers (81, 82) is modified in order to modify its pressure and to displace the liquid of interest toward one of the expansion chambers (61, 62), without breaking the isolation of the operative cavity (3),
d) the temperature of the residual gas present in at least one of the trapping chambers (81, 82) is again modified in order to again modify its pressure and to displace the liquid of interest toward the other of the expansion chambers (61, 62), without breaking the isolation of the operative cavity (3).

The pressure obtained in step (d) is the equilibrium pressure.

Preferably, steps (c) and (d) are repeated.

The operations described above can be brought about a whole number of times, so as to generate oscillations in the discrete quota (20) on either side of the operative cavity (3), through the latter, the residual gas being compressed in each direction, or in the expansion chamber (62) or in the expansion chamber (61), and each time exerting a return action in the opposite direction.

As described above with reference to FIGS. 1 to 3, it is observed that not only is an agitating function obtained, but also an isolating function, since the volume of the liquid of interest, present in the operative cavity (3) is isolated, with the discrete quota (20) of the same liquid, representing in general a few % of the volume of the operative cavity (3). In particular, the capillary valves (71, 72, 51, 52, 101 and 102) play exactly the same role in the agitating function as in the purely isolating function.

By means of the same capillary valves, the residual gas is compressed, without being able to flow either toward the inlet duct (41) or toward the outlet duct (42). Thus, the residual gas can play a shock-absorbing role in the agitating function described above.

The quota (20) of the liquid of interest is determined via the combination of the geometry of the expansion chambers (61) and (62), and the choice of the “agitation” temperatures disclosed above.

As shown in FIGS. 9 to 11, the expansion chambers (61) or (62) may have a predetermined geometry so as to obtain a “threshold” structure.

According to these figures, each expansion chamber (61) or (62) comprises, in the direction of the operative cavity (3), two successive narrowings A and B, toward diameters or cross sections that are respectively less with respect to one another. Consequently, starting with complete filling of the expansion chamber (61) according to FIG. 9, in order to have complete evacuation, it is required to increase the temperature in a nonlinear manner, in two stages or thresholds, given the increase in the capillary force from one narrowing to another, at the interface or meniscus between the liquid of interest and the residual gas. These allow a discrete variation in volume, or a variation in stages, and therefore more flexible thermal control of the fluidic device according to the invention, either in isolating mode or in agitating mode, or both.

Of course, the agitation described above with reference to FIGS. 7 and 8 can be obtained with preselected amplitudes and frequencies. It occurs locally in the device and does not require the introduction of particles or of other means, since the residual gas alone, trapped passively during the filling with the liquid of interest, is the only means used for this purpose, at the periphery or outside the liquid of interest isolated.

Overall, by means of the fluidic device according to the invention, it is possible, particularly simply and merely with a thermal or other control, to obtain both an isolation in the operative cavity (3) against any leakage of said liquid and/or diffusion of particles to the outside, or the same isolation but with agitation.

A fluidic device as described or defined above is particularly suitable for carrying out a method, such as ELISA or ELOSA, for determining a target species, or analyte, described schematically hereinafter with reference to FIG. 13.

According to this method, it involves determining, i.e. qualitatively and/or quantitatively detecting, a target species or analyte (C), comprising two sites (C1, C2) for binding, respectively, with a first ligand (L1) and with a second ligand (L2) linked directly or indirectly to a label E.

To this ends the method comprises the following steps:
a) a support (M₁) is provided, functionalized with the first ligand (L₁), placed for example in a liquid medium, in an incubation chamber (not represented),
b) still in a liquid medium, in the incubation chamber, the functionalized support (M₁, L₁), the target species (C) or analyte, and the labeled second ligand (L₂, E) are brought into contact successively or simultaneously so as to obtain a complex 300 combining the support (M₁), the first ligand (L₁), the target species (C) and the labeled second ligand (L₂, E),
c) another support (M₂) functionalized 303 with a third ligand (L₃), capable of binding to the target species (C), is provided, for example in a liquid medium or in contact with a liquid medium,
d) the complex 300 is combined in an orientated manner, so as to separate a conjugate 301 combining the target species (C) and the labeled second ligand (L₂, E), from the functionalized (M1, L1) support 302,
e) in a liquid medium, the other functionalized (M₂, L₃) support 303 is brought into contact with the conjugate 301, so as to obtain another complex 304 combining the other support (M₂), the third ligand (L₃), the target species (C) and the labeled second ligand (L₂, E),
f) the label E of the other complex (304) is qualitatively and/or quantitatively detected.

This method, defined in general, of the immunoassay type, may be the subject of various adjustments or additions, in particular according to the analyte (C), or to the device for implementing it. Thus:
the third ligand (L₃) may be identical to or different from the first ligand (L₁), step e) may be carried out in an chamber that is identical to or different from the incubation chamber, making it possible to obtain the initial complex 300,
the support (M₁) and/or the other support (M₂) may be in a divided form, for example of particles, which may comprise or contain, where appropriate, a magnetic material,
the actions of bringing into contact according to steps (b) and (e), in a liquid medium, take place in two different incubation chambers,
prior to the dissociation step (d), a fraction enriched in complex 300 is separated from the liquid medium obtained, subsequent to the act of bringing into contact,
after or during step (b), various washes may be performed, firstly in order to remove the excess labeled second ligand (L₂, E) and, secondly, in order to remove the same, weakly adsorbed, reactant from the functionalized support (M₁, L₁),
by working in a liquid medium, and in particular with supports (M₁) and/or (M₂) in the form of magnetic particles, it is possible to separate the conjugate 301 from the supernatant of the liquid medium.

In a manner well known to those skilled in the art in the immunoassay field:
the term “target species” or “analyte” is intended to mean any entity, in particular a biological entity, that it is desired to determine, i.e. to qualitatively and/or quantitatively detect; by way of example, it is an antibody or an antigen, or else a polynucleotide;
the term “ligand” is intended to mean any entity capable of binding, for example specifically, by means of weak bonds, for example of the hydrogen type, with a “binding” site belonging to the target species; it is, for example, an antibody or an antigen, or else a polynucleotide that is in part complementary to a target polynucleotide;
the term “support” is intended to mean any substrate, in divided or non divided form, that is generally inert in nature with respect to the analyte and/or a ligand, making it possible to attach an editorial entity, for example a ligand by functionalization;
the term “functionalization” is intended to mean any chemical treatment of the chemical, physicochemical or biochemical, or alternatively biological, type for attaching the abovementioned editorial entity to the support.

In order to carry out a method of determination as defined above, a device in accordance with FIG. 1 is adapted, as shown in FIG. 14, in the following way:
it comprises an incubation chamber 305, the outlet 306 of which communicates with the inlet duct 41 of the device according to the invention, and the operative cavity 12 comprises, in the form of filling like a chromatography column, particles 303 as defined above, i.e. the support (M₂) functionalized with the third ligand (L₃),
a means 307, for example a heating means, for orientated dissociation is placed in contact with the inlet duct 41, at the outlet of the incubation chamber 305, so as to allow dissociation of the complex 300, defined above, between the support (M₁), the first ligand (L₁), and the target species (C), and the labeled second ligand (M₁, L₂); this means 307 can be combined, where appropriate, with a means of concentrating with complex 300,
a means 308 for retaining particles, for example of the magnetic type, is placed downstream of the means 307 of dissociation, still in contact with the inlet duct 41, so as to retain the particles of the functionalized support 302, dissociated from the complex 300.

In this way, the conjugate 301 can circulate to the operative cavity (3) and bind, in the latter, with the particles of the functionalized (M₂, L₃) support 303.

1-21. (canceled)

22. A fluidic device produced from one or more components, for example from a support comprising:
an operative cavity,
at least two ducts, for example an inlet duct and an outlet duct for a liquid of interest, which communicate with the operative cavity, respectively by means of two valve bodies with no moving parts, of the type, for controlling the operative cavity,
two trapping chambers for a gas, for example air, which communicate only and respectively with the two ducts and, by means of two distinct channels for connecting, respectively, said two ducts,
means for heat exchange with one and/or the other trapping chamber, in order to control the pressure of the gas in one and/or the other trapping chamber.

23. The device as claimed in claim 22, characterized in that each body with no moving parts is a capillary valve.

24. The device as claimed in claim 22, characterized in that each capillary valve is constructed so as to generate an overpressure at the interface between the gas and the liquid of interest, referred to as a meniscus, that opposes any displacement of the liquid beyond the valve, against the overpressure.

25. The device as claimed in claim 22, characterized in that each capillary valve comprises a base, the cross section of which increases in the direction of the concavity of said meniscus when the liquid of interest is wetting, or the cross section of which decreases in the direction of said concavity when said liquid of interest is not wetting.

26. The device as claimed in claim 22, characterized in that it comprises two isolating means placed, respectively, on the two ducts, each constructed to take up two positions, namely an open position which establishes communication from one said duct with the outside, and a closed position which isolates said duct from the outside.

27. The device as claimed in claim 22, characterized in that it comprises two expansion chambers, each one placed between said operative cavity and each duct, each chamber communicating, on one side, with said duct by means of a first capillary valve with no moving parts, that opposes any flow of liquid to said chamber and, on the other side, with said cavity by means of a second capillary valve that opposes any flow of liquid to said chamber.

28. The device as claimed in claim 27, characterized in that the two connecting channels each connect a trapping chamber with an expansion chamber.

29. The device as claimed in claim 27, characterized in that each connecting channel communicates with the corresponding expansion chamber by means of a capillary valve with no moving parts, that opposes any flow of liquid to said trapping chamber.

30. The device as claimed in claim 27, characterized in that the two expansion chambers are substantially identical, in particular in volume.

31. The device as claimed in claim 22, characterized in that the two trapping chambers are substantially identical, in particular in volume.

32. The device as claimed in claim 22, characterized in that it comprises an incubation chamber, the outlet of which communicates with the inlet duct, and the operative cavity comprises, in the form of particles, a support functionalized with a ligand.

33. The device as claimed in claim 22, characterized in that a means for oriented dissociation, for example a heating means, is placed in contact with the inlet duct.

34. The device as claimed in claim 33, characterized in that a means for retaining particles, for example magnetic particles, is placed in contact with the inlet duct, downstream with respect to the means for oriented dissociation.
